(19) United States
(12) Patent Application Publication
(10) Pub. No.: US 2016/0189234 A1
(43) Pub. Date: Jun. 30, 2016

(54) SELECTING CONTENT ITEMS FOR PRESENTATION TO A SOCIAL NETWORKING SYSTEM USER BASED IN PART ON CONTENT ITEM APPEARANCE

(71) Applicant: Facebook, Inc., Menlo Park, CA (US)

(72) Inventors: Yi Tang, Mountain View, CA (US); Jonathan Mooser, Mountain View, CA (US); Yinan Na, Mountain View, CA (US); Jeffrey William Pasternack, Belmont, CA (US); Shuo Li, Mountain View, CA (US)

(21) Appl. No.: 14/582,252

(22) Filed: Dec. 24, 2014

(51) Int. Cl. G06Q 30/02; G06Q 50/00

(52) U.S. Cl. CPC G06Q 30/0269; G06Q 50/01

(57) ABSTRACT

A social networking system selects content items for presentation to a user. To promote user interaction with selected content items, the social networking system scores content items based at least in part on similarity in appearances of the content items to an appearance of a content item for which the social networking system is compensated for presentation (a “sponsored content item”). For example, a model is applied to features describing appearance of a content item to generate the score for a content item. When selecting content items for presentation, a score associated with a content item may modify the likelihood of the content item being selected. A content item with a score indicating greater than a threshold similarity in appearance to an appearance of a sponsored content item may be penalized when the social networking system selects content for presentation.

### BACKGROUND

This disclosure relates generally to content presentation by social networking systems, and more specifically to presenting sponsored and non-sponsored content to a user of a social networking system.

A social networking system allows its users to connect to and communicate with other online system users. Users may create profiles on the social networking system that are tied to their identities and include information about the users, such as interests and demographic information. The users may be individuals or entities such as corporations or charities. Establishing connections with other users via a social networking system allows a user to more easily share content with the other users.

Users of a social networking system share their interests and engage with other users of the social networking system by sharing or generating content items such as photographs, status updates, and playing social games. This causes a social networking system to receive a large amount of information from users describing a variety of events or actions, ranging from events including moves to a new city, graduations, births, engagements, marriages, and the like, as well as more mundane content such as status messages, information about what music has been listened to by users, and recent check-in events at coffee shops. While this allows social networking system users to easily exchange information with other social networking system users, the amount of information the social networking system gathers from users is staggering.

A social networking system presents various content items to a user based on the information it receives from other users. For example, the social networking system presents a user with non-sponsored content items, which describe actions performed by other social networking system users connected to the user via the social networking system. Entities (e.g., a business) may be connected to the user via the social networking system and present non-sponsored content items, such as images or information associated with upcoming events, to the user. Additionally, sponsored content items, such as advertisements, may also be presented to the user and may be selected for presentation based information associated with the user by the social networking system. For example, the social networking system presents a feed of content items to the user that includes non-sponsored content and sponsored content items. Because of the large amount of information received by a social networking system, the feed presented to the user may include a large number of content items.

However, certain non-sponsored content items, such as content items including graphics and large images, may look similar to sponsored content items when presented to a user by a social networking system. Because a large number of content items, both sponsored and non-sponsored, may be presented to a social networking system user, if the social networking system presents a user with content that appears to include a large number of sponsored content items, user interaction with the social networking system may decrease. For example, if a feed of content items includes a large number of sponsored content items and non-sponsored content items that look similar to sponsored content items is presented to the user by the social networking system, the likelihood of the user interacting with the feed decreases.

### SUMMARY

A social networking system presents content items to a user of the social networking system. For example, the social networking system presents the user with a feed including various content items. Different types of content items may be presented to the user via the feed. For example, the feed includes non-sponsored content items, which may be stories describing actions performed by other social networking system users, and sponsored content items for which the social networking system receives compensation for presenting (e.g., advertisements).

To increase the likelihood of the user interacting with content presented by the social networking system, the social networking system accounts for appearances of various content items when selecting content items for presentation to the user. The social networking system obtains content items for presentation to the user and scores the obtained content items based at least in part on their appearances. In one example, the social networking system applies one or more machine learned models to features of a content item that generates a score based on similarity between features describing appearance of the content items and features describing appearances of content items previously identified as sponsored content items. Hence, the score provides a measure of similarity of features of the content item to features associated with an appearance of a sponsored content item. The model may be trained via a training set of content items and user feedback regarding user perception of content items having various features as sponsored or as non-sponsored content items. In some embodiments, a higher score associated with a content item indicates features of describing appearance of the content item have higher similarity to features describing appearance of a sponsored content item. For example, a score associated with a content item is proportional to a number or a percentage of features of the content item matching or similar to features of content items previously perceived by users to be sponsored content items

Based at least in part on a score associated with a content item, the social networking system determines whether the content item has an appearance of a sponsored content item or an appearance of a non-sponsored content item. For example, the social networking system determines the content item has the appearance of a sponsored content item if the score associated with the content item exceeds a threshold value and determines the content item has an appearance of a non-sponsored content item if the score associated with the content item is less than the threshold value. Additional information associated with the content item may also be used to determine whether the content item has the appearance of a sponsored content item. For example, if a bid amount is associated with the content item, the social networking system determines the content item has the appearance of a sponsored content item.

When selecting content items for presentation to a user, the social networking system accounts for the scores associated with the content item. The social networking system may identify candidate content items based on likelihoods of the user interacting with the candidate content items as well as bid amounts associated with the candidate content items. For example, each candidate content item has at least a threshold likelihood of user interaction or has at least a threshold value determined from the likelihood of user interaction and bid amount associated with the content item. The scores providing measures of similarity of features of candidate content items to features associated with an appearance of a sponsored content item are used to select candidate content items for presentation to the user. In one embodiment, the social networking system applies one or more rules based on the scores associated with the candidate content items to select a set of candidate content items for presentation to the user. For example, a rule specifies a maximum number of content items having an appearance of a sponsored content items included in a feed of content items for presentation to the user. Hence, when selecting content items for inclusion in a feed, the social networking system selects candidate content items associated with scores less than a threshold value. As another example, a rule specifies a minimum number of content items having an appearance of a non-sponsored content item presented between content items having appearances of sponsored content items in the feed. After selecting a candidate content item having an appearance of a sponsored content item for inclusion in the feed, the social networking system selects at least the minimum number of candidate content items having scores indicating the candidate content item have appearances of non-sponsored content items (e.g., candidate content items associated with less than the threshold score) before selecting another candidate content item having the appearance of a sponsored content item for inclusion in the feed. The social networking system communicates the feed including the selected candidate content items to a client device associated with the user for presentation.

### BRIEF DESCRIPTION OF THE DRAWINGS

FIG. 1 is a block diagram of a system environment in which a social networking system operates, in accordance with an embodiment.

FIG. 2 is a block diagram of a social networking system, in accordance with an embodiment.

FIG. 3 is an example of sponsored content items and non-sponsored content items presented to a social networking system user, in accordance with an embodiment.

FIG. 4 is a flowchart of a method for one or more machine learned models model to generate a score providing a measure of similarity between an appearance of a content item and an appearance of a sponsored content item, in accordance with an embodiment.

FIG. 5 is a flow chart of a method for selecting content items for presentation to a social networking system user, in accordance with an embodiment.

The figures depict various embodiments for purposes of illustration only. One skilled in the art will readily recognize from the following discussion that alternative embodiments of the structures and methods illustrated herein may be employed without departing from the principles described herein.

### DETAILED DESCRIPTION

System Architecture

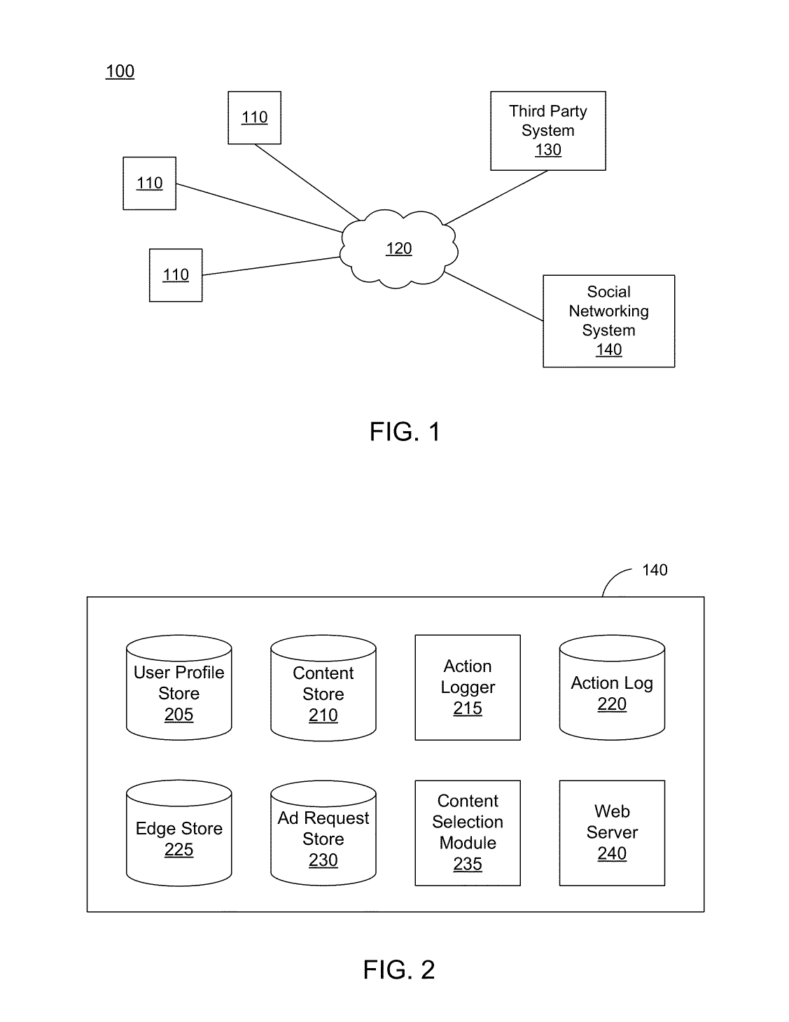

FIG. 1 is a block diagram of a system environment 100 for a social networking system 140. The system environment 100 shown by FIG. 1 comprises one or more client devices 110, a network 120, one or more third-party systems 130, and the social networking system 140. In alternative configurations, different and/or additional components may be included in the system environment 100. The embodiments described herein can be adapted to online systems that are not social networking systems.

The client devices 110 are one or more computing devices capable of receiving user input as well as transmitting and/or receiving data via the network 120. In one embodiment, a client device 110 is a conventional computer system, such as a desktop or a laptop computer. Alternatively, a client device 110 may be a device having computer functionality, such as a personal digital assistant (PDA), a mobile telephone, a smartphone or another suitable device. A client device 110 is configured to communicate via the network 120. In one embodiment, a client device 110 executes an application allowing a user of the client device 110 to interact with the social networking system 140. For example, a client device 110 executes a browser application to enable interaction between the client device 110 and the social networking system 140 via the network 120. In another embodiment, a client device 110 interacts with the social networking system 140 through an application programming interface (API) running on a native operating system of the client device 110, such as IOS® or ANDROID™.

The client devices 110 are configured to communicate via the network 120, which may comprise any combination of local area and/or wide area networks, using both wired and/or wireless communication systems. In one embodiment, the network 120 uses standard communications technologies and/or protocols. For example, the network 120 includes communication links using technologies such as Ethernet, 802.11, worldwide interoperability for microwave access (WiMAX), 3G, 4G, code division multiple access (CDMA), digital subscriber line (DSL), etc. Examples of networking protocols used for communicating via the network 120 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 120 may be represented using any suitable format, such as hypertext markup language (HTML) or extensible markup language (XML). In some embodiments, all or some of the communication links of the network 120 may be encrypted using any suitable technique or techniques.

One or more third party systems 130 may be coupled to the network 120 for communicating with the social networking system 140, which is further described below in conjunction with FIG. 2. In one embodiment, a third party system 130 is an application provider communicating information describing applications for execution by a client device 110 or communicating data to client devices 110 for use by an application executing on the client device. In other embodiments, a third party system 130 provides content or other information for presentation via a client device 110. A third party system 130 may also communicate information to the social networking system 140, such as advertisements, content, or information about an application provided by the third party system 130.

FIG. 2 is an example block diagram of an architecture of the social networking system 140. The social networking system 140 shown in FIG. 2 includes a user profile store 205, a content store 210, an action logger 215, an action log 220, an edge store 225, an advertisement (“ad”) request store 230, a content selection module 235, and a web server 240. In other embodiments, the social networking system 140 may include additional, fewer, or different components than those described in conjunction with FIG. 2. Conventional components such as network interfaces, security functions, load balancers, failover servers, management and network operations consoles, and the like are not shown so as to not obscure the details of the system architecture.

Each user of the social networking system 140 is associated with a user profile, which is stored in the user profile store 205. A user profile includes declarative information about the user that was explicitly shared by the user and may also include profile information inferred by the social networking system 140. In one embodiment, a user profile includes multiple data fields, each describing one or more attributes of the corresponding social networking system user. Examples of information stored in a user profile include biographic, demographic, and other types of descriptive information, such as work experience, educational history, gender, hobbies or preferences, location and the like. A user profile may also store other information provided by the user, for example, images or videos. In certain embodiments, images of users may be tagged with information identifying social networking system users displayed in an image. A user profile in the user profile store 205 may also maintain references to actions by the corresponding user performed on content items in the content store 210 and stored in the action log 220.

While user profiles in the user profile store 205 are frequently associated with individuals, allowing individuals to interact with each other via the social networking system 140, user profiles may also be stored for entities such as businesses or organizations. This allows an entity to establish a presence on the social networking system 140 for connecting and exchanging content with other social networking system users. The entity may post information about itself, about its products or provide other information to users of the social networking system using a brand page associated with the entity's user profile. For example, an entity may post an image of a product associated with the entity to other users of the social networking system 140. Other users of the social networking system may connect to the brand page to receive information posted to the brand page or to receive information from the brand page. A user profile associated with the brand page may include information about the entity itself, providing users with background or informational data about the entity.

The content store 210 stores objects that each represent various types of content. Examples of content represented by an object include a page post, a status update, a photograph, a video, a link, a shared content item, a gaming application achievement, a check-in event at a local business, a brand page, or any other type of content. Social networking system users may create objects stored by the content store 210, such as status updates, photos tagged by users to be associated with other objects in the social networking system 140, events, groups or applications. In some embodiments, objects are received from third-party applications or third-party applications separate from the social networking system 140. In one embodiment, objects in the content store 210 represent single pieces of content, or content “items.” Hence, social networking system users are encouraged to communicate with each other by posting text and content items of various types of media to the social networking system 140 through various communication channels. This increases the amount of interaction of users with each other and increases the frequency with which users interact within the social networking system 140.

Content items stored by the content store 210 include non-sponsored content items or sponsored content items. A non-sponsored content item is presented by the social networking system 140 to one or more users without the social networking system 140 receiving compensation. For example, a non-sponsored content item is a story describing an action performed by a social networking system user generated by the social networking system 140 and subsequently presented by the social networking system 140 to an additional user. A sponsored content item is associated with a bid amount that specifies an amount of compensation received by the social networking system 140 from a user when the sponsored content item is presented to another social networking system user. Sponsored content items may include advertisements that may be stored in the ad request store 230, further described below, or may be stored in the content store 210. The social networking system 140 uses a bid amount associated with a sponsored content item when selecting content for presentation to the user, as further described below.

The action logger 215 receives communications about user actions internal to and/or external to the social networking system 140, populating the action log 220 with information about user actions. Examples of actions include adding a connection to another user, sending a message to another user, uploading an image, reading a message from another user, viewing content associated with another user, and attending an event posted by another user. In addition, a number of actions may involve an object and one or more particular users, so these actions are associated with those users as well and stored in the action log 220.

The action log 220 may be used by the social networking system 140 to track user actions on the social networking system 140, as well as actions on third party systems 130 that communicate information to the social networking system 140. Users may interact with various objects on the social networking system 140, and information describing these interactions is stored in the action log 220. Examples of interactions with objects include: commenting on posts, sharing links, and checking-in to physical locations via a client device 110, accessing content items, and any other suitable interactions. Additional examples of interactions with objects on the social networking system 140 that are included in the action log 220 include: commenting on a photo album, communicating with a user, establishing a connection with an object, joining an event, joining a group, creating an event, authorizing an application, using an application, expressing a preference for an object (“liking” the object) and engaging in a transaction. Additionally, the action log 220 may record a user's interactions with advertisements on the social networking system 140 as well as with other applications operating on the social networking system 140. In some embodiments, data from the action log 220 is used to infer interests or preferences of a user, augmenting the interests included in the user's user profile and allowing a more complete understanding of user preferences.

The action log 220 may also store user actions taken on a third party system 130, such as an external website, and communicated to the social networking system 140. For example, an e-commerce website may recognize a user of a social networking system 140 through a social plug-in enabling the e-commerce website to identify the user of the social networking system 140. Because users of the social networking system 140 are uniquely identifiable, e-commerce websites, such as in the preceding example, may communicate information about a user's actions outside of the social networking system 140 to the social networking system 140 for association with the user. Hence, the action log 220 may record information about actions users perform on a third party system 130, including webpage viewing histories, advertisements that were engaged, purchases made, and other patterns from shopping and buying.

In one embodiment, the edge store 225 stores information describing connections between users and other objects on the social networking system 140 as edges. Some edges may be defined by users, allowing users to specify their relationships with other users. For example, users may generate edges with other users that parallel the users' real-life relationships, such as friends, co-workers, partners, and so forth. Other edges are generated when users interact with objects in the social networking system 140, such as expressing interest in a page on the social networking system 140, sharing a link with other users of the social networking system 140, and commenting on posts made by other users of the social networking system 140.

In one embodiment, an edge may include various features each representing characteristics of interactions between users, interactions between users and objects, or interactions between objects. For example, features included in an edge describe rate of interaction between two users, how recently two users have interacted with each other, the rate or amount of information retrieved by one user about an object, or the number and types of comments posted by a user about an object. The features may also represent information describing a particular object or user. For example, a feature may represent the level of interest that a user has in a particular topic, the rate at which the user logs into the social networking system 140, or information describing demographic information about a user. Each feature may be associated with a source object or user, a target object or user, and a feature value. A feature may be specified as an expression based on values describing the source object or user, the target object or user, or interactions between the source object or user and target object or user; hence, an edge may be represented as one or more feature expressions.

The edge store 225 also stores information about edges, such as affinity scores for objects, interests, and other users. Affinity scores, or “affinities,” may be computed by the social networking system 140 over time to approximate a user's interest in an object or in another user in the social networking system 140 based on the actions performed by the user. A user's affinity may be computed by the social networking system 140 over time to approximate a user's interest for an object, a topic, or another user in the social networking system 140 based on the actions performed by the user. Computation of affinity is further described in U.S. patent application Ser. No. 12/978,265, filed on Dec. 23, 2010, U.S. patent application Ser. No. 13/690,254, filed on Nov. 30, 2012, U.S. patent application Ser. No. 13/689,969, filed on Nov. 30, 2012, and U.S. patent application Ser. No. 13/690,088, filed on Nov. 30, 2012, each of which is hereby incorporated by reference in its entirety. Multiple interactions between a user and a specific object may be stored as a single edge in the edge store 225, in one embodiment. Alternatively, each interaction between a user and a specific object is stored as a separate edge. In some embodiments, connections between users may be stored in the user profile store 205, or the user profile store 205 may access the edge store 225 to determine connections between users.

One or more advertisement requests (“ad requests”) are included in the ad request store 230. An advertisement request includes advertisement content (also referred to as an “advertisement”) and a bid amount. The advertisement content is text, image, audio, video, or any other suitable data presented to a user. In various embodiments, the advertisement content also includes a landing page specifying a network address to which a user is directed when the advertisement is accessed. The bid amount is associated with an ad request by an advertiser and is used to determine an expected value, such as monetary compensation, provided by an advertiser to the social networking system 140 if advertisement content in the ad request is presented to a user, if the advertisement content in the ad request receives a user interaction when presented to a user, or if any suitable condition is satisfied when advertisement content in the ad request is presented to a user. For example, the bid amount specifies a monetary amount that the social networking system 140 receives from the advertiser if advertisement content included in an ad request is displayed. The expected value to the social networking system 140 of presenting the advertisement content may be determined by multiplying the bid amount by a probability of the advertisement content being accessed by a user. Thus, advertisement content included in an ad request is a sponsored content item.

Additionally, an advertisement request may include one or more targeting criteria specified by the advertiser. Targeting criteria included in an advertisement request specify one or more characteristics of users eligible to be presented with advertisement content in the advertisement request. For example, targeting criteria are used to identify users having user profile information, edges or actions satisfying at least one of the targeting criteria. Hence, targeting criteria allow an advertiser to identify users having specific characteristics, simplifying subsequent distribution of content to different users.

In one embodiment, targeting criteria may specify actions or types of connections between a user and another user or object of the social networking system 140. Targeting criteria may also specify interactions between a user and objects performed external to the social networking system 140, such as on a third party system 130. For example, targeting criteria identifies users that have taken a particular action, such as sending a message to another user, using an application, joining a group, leaving a group, joining an event, generating an event description, purchasing or reviewing a product or service using an online marketplace, requesting information from a third-party system 130, or any other suitable action. Including actions in targeting criteria allows advertisers to further refine users eligible to be presented with content from an advertisement request. As another example, targeting criteria identifies users having a connection to another user or object or having a particular type of connection to another user or object.

The content selection module 235 selects one or more content items for communication to a client device 110 to be presented to a viewing user. Content items eligible for presentation to the viewing user are retrieved from the content store 210, or from another source, by the content selection module 235, which selects one or more of the content items for presentation to the viewing user. A content item eligible for presentation to the viewing user is a content item associated with at least a threshold number of targeting criteria satisfied by characteristics of the viewing user or is a content item that is not associated with targeting criteria. In various embodiments, the content selection module 235 includes content items eligible for presentation to the viewing user in one or more selection processes, which identify a set of content items for presentation to the viewing user. For example, the content selection module 235 determines a measure of relevance of various content items to the user based on characteristics associated with the user by the social networking system 140 based on the user's affinity for different content items and selects content items for presentation to the user based on the determined measures of relevance. As an additional example, the content selection module 235 selects content items having the highest measures of relevance or having at least a threshold measure of relevance for presentation to the user. Alternatively, the content selection module 235 ranks content items based on their associated measures of relevance and selects content items having the highest positions in the ranking or having at least a threshold position in the ranking for presentation to the user.

Content items selected for presentation to the user may include ad requests or other content items associated with bid amounts. The content selection module 235 uses the bid amounts associated with various content items when selecting content for presentation to the viewing user. In various embodiments, the content selection module 235 determines an expected value associated with various content items based on their bid amounts and selects content items associated with a maximum expected value or associated with at least a threshold expected value for presentation. An expected value associated with a content item represents an expected amount of compensation to the social networking system 140 for presenting a content item. For example, the expected value associated with an ad request is a product of the ad request's bid amount and a likelihood of the user interacting with the ad content from the ad request. The content selection module 235 may rank ad requests based on their associated expected values and select ad requests having at least a threshold position in the ranking for presentation to the user. In some embodiments, the content selection module 235 may rank both content items and ad requests in a unified ranking based on bid amounts associated with ad requests and measures of relevance associated with content items and ad requests. Based on the unified ranking, the content selection module 235 selects content for presentation to the user. Selecting ad requests and other content items through a unified ranking is further described in U.S. patent application Ser. No. 13/545,266, filed on Jul. 10, 2012, which is hereby incorporated by reference in its entirety.

For example, the content selection module 235 receives a request to present a feed of content to a user of the social networking system 140. The feed may include one or more advertisements as well as content items, such as stories describing actions associated with other online system users connected to the user. The content selection module 235 accesses one or more of the user profile store 205, the content store 210, the action log 220, and the edge store 225 to retrieve information about the identified user. For example, stories or other data associated with users connected to the identified user are retrieved. Additionally, one or more advertisement requests (“ad requests”) may be retrieved from the ad request store 230. The retrieved stories, ad requests, or other content items, are analyzed by the content selection module 235 to identify content likely to be relevant to the identified user. For example, stories associated with users not connected to the identified user or stories associated with users for which the identified user has less than a threshold affinity are discarded as candidate stories. Based on various criteria, the content selection module 235 selects one or more of the candidate stories for presentation to the identified user. Candidate stories or advertisements are selected for inclusion in the feed of content as described above.

In various embodiments, the content selection module 235 presents content to a user through a newsfeed including a plurality of content items selected for presentation to the user. One or more advertisements may also be included in the feed. The content selection module 235 may also determine the order in which selected content items or advertisements are presented via the feed. For example, the content selection module 235 orders content items or advertisements in the feed based on likelihoods of the user interacting with various content items or advertisements.

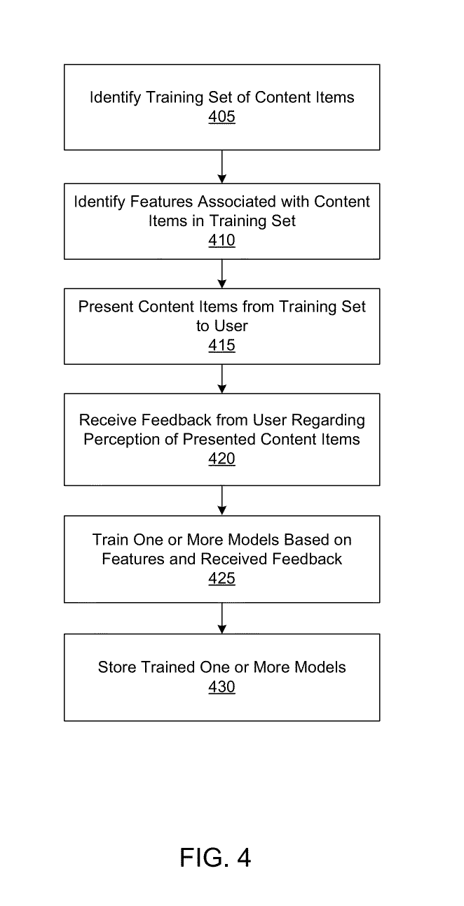

To improve user interaction with content provided by the social networking system 140, the content selection module 235 scores content items eligible for presentation to a user based on the appearances of the content items. A user may less frequently interact with content items that have an appearance of a sponsored content item, even if the content items are non-sponsored content items. Hence, the content selection module 235 generates a score for a content item that provides a measure of similarity of an appearance of the content item to an appearance of a sponsored content item (e.g., an advertisement). In various embodiments, the content selection module 235 generates the score for a content item based at least in part on features of the content item describing appearance of the content item. For example, the content selection module 235 identifies features of the content item and applies one or more machine learned models to the identified features to generate the score for the content item. If the score for the content item exceeds a threshold value, the content selection module 235 determines the content item has an appearance having at least a threshold similarity to an appearance of a sponsored content item. The content selection module 235 may initially train the one or more machine learned models based on feedback received from users presented with content items in a training set; if a threshold number of users identify a content item from the training set as having an appearance of a sponsored content item, the content selection module 235 identifies features from the content item from the training set and trains a machine learned model based on the identified features. Training of one or more machine learned models to score a content item based on similarity of the content item's appearance to an appearance of a sponsored content item is further described below in conjunction with FIG. 4. Alternatively, the content selection module applies one or more machine learned models to the identified features of the content item to determine a score describing a similarity in appearance of the content item to an appearance of a non-sponsored content item.

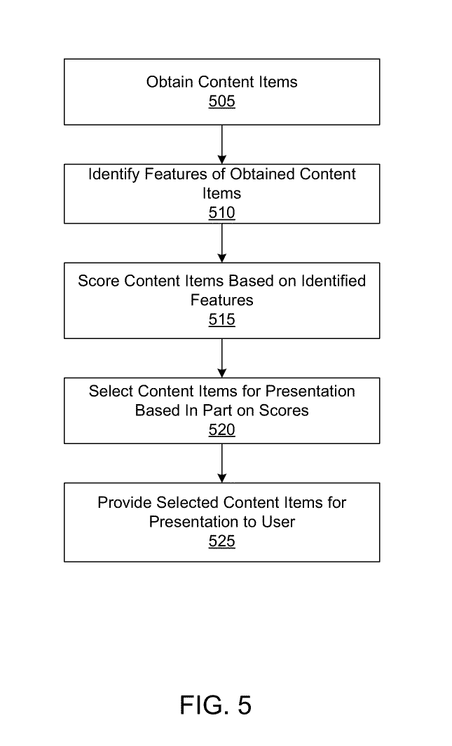

Selection of content for presentation to users is then based at least in part on scores associated with various content items eligible for presentation to the user. In one embodiment, the content selection module 235 selects content items for inclusion in a feed of content that is communicated to a client device 110 for presentation to the user. When selecting content for presentation to a user, the content selection module 235 accounts for the scores indicating similarity in appearance between content items eligible for presentation to the user and an appearance of a sponsored content item. In various embodiments, the content selection module 235 applies one or more rules based at least in part on the scores associated with the content items eligible for presentation to the user. For example, a rule specifies a maximum ratio of content items with appearances similar to an appearance of a sponsored content item and content items with appearances not similar to the appearance of the sponsored content item for inclusion in the feed. Hence, when selecting content items for inclusion in the feed, the content selection module 235 selects a number of content items having scores exceeding a threshold value (i.e., a number of content items having an appearance of a sponsored content item) and a number of content items having scores less than the threshold value (i.e., a number of content items having an appearance of a non-sponsored content item) so the maximum ratio is not exceeded. As another example where the feed comprises multiple positions, with a content item presented in each position, the content selection module 235 enforces one or more rules specifying a minimum distance in the feed between content items having scores equaling or exceeding the threshold value. In this example, after selecting a content item having a score exceeding the threshold value, the content selection module 235 selects content items having scores less than the threshold value when selecting content for at least a number of positions equaling the minimum distance. Selection of content based at least in part on scores associated with content items is further described below in conjunction with FIG. 5.

The content selection module 235 may also store a “view state” associated with each user of the social networking system 140 that identifies content items presented to each user and the order in which content items were presented to each user. The view state associated with a user at a particular time may be stored in a view state object associated with the user in the user profile store 205. When a user requests content from the social networking system 140, a feed of content items (e.g., an image generated by a user or advertisements) is provided to a client device 110 associated with the user for presentation. As content items from the feed are presented by the client device 110, information identifying the content items presented by the client device 110 is communicated to the social networking system 140, which modifies the view state associated with the user based on the received information. For example, the view state associated with the user is modified to identify content items presented to the user via the client device 110 and an order in which the content items were presented (e.g., positions in a feed associated with various content items). The modified view state is stored in association with a user profile associated with the user. In one embodiment, the view state associated with the user is modified when the user's session interacting with the social networking system 140 expires. For example, the user's session with the social networking system 140 expires based on a lack of engagement by the user with the social networking system 140 or based on an express request by the user to end the session with the social networking system 140. As an example, a user opens a window of a web browser on a client device 110 to view content provided by the social networking system 140. After viewing content provided by the social networking system 140, the user opens another browser window to view content provided by sources other than the social networking system 140; if the user does not interact with the window of the web browser including content provided by the social networking system 140 for at least a threshold amount of time, the social networking system 140 determines the user's session interacting with the social networking system 140 has expired. As another example, the user's session interacting with the social networking system ends expired when the user logs out of the social networking system 140. When a session of a user expires, the view state, which includes an order in which content items were presented via a feed, an identification of content items presented by the client device 110, indications of whether content items were featured or highlighted is modified based on information describing presentation of content by the client device 110. The modified view state is stored in the content store 210 and associated with the user's user profile stored in the user profile store 205.

The web server 240 links the social networking system 140 via the network 120 to the one or more client devices 110, as well as to the one or more third party systems 130. The web server 240 serves web pages, as well as other web-related content, such as JAVA®, FLASH®, XML and so forth. The web server 240 may receive and route messages between the social networking system 140 and the client device 110, for example, instant messages, queued messages (e.g., email), text messages, short message service (SMS) messages, or messages sent using any other suitable messaging technique. A user may send a request to the web server 240 via the client device 110 for content items to be presented to the user via a feed of content. Additionally, the web server 240 may provide application programming interface (API) functionality to send data directly to native client device operating systems, such as IOS®, ANDROID™, WEBOS® or BlackberryOS.

### Example Content Items Presented to Social Networking System User

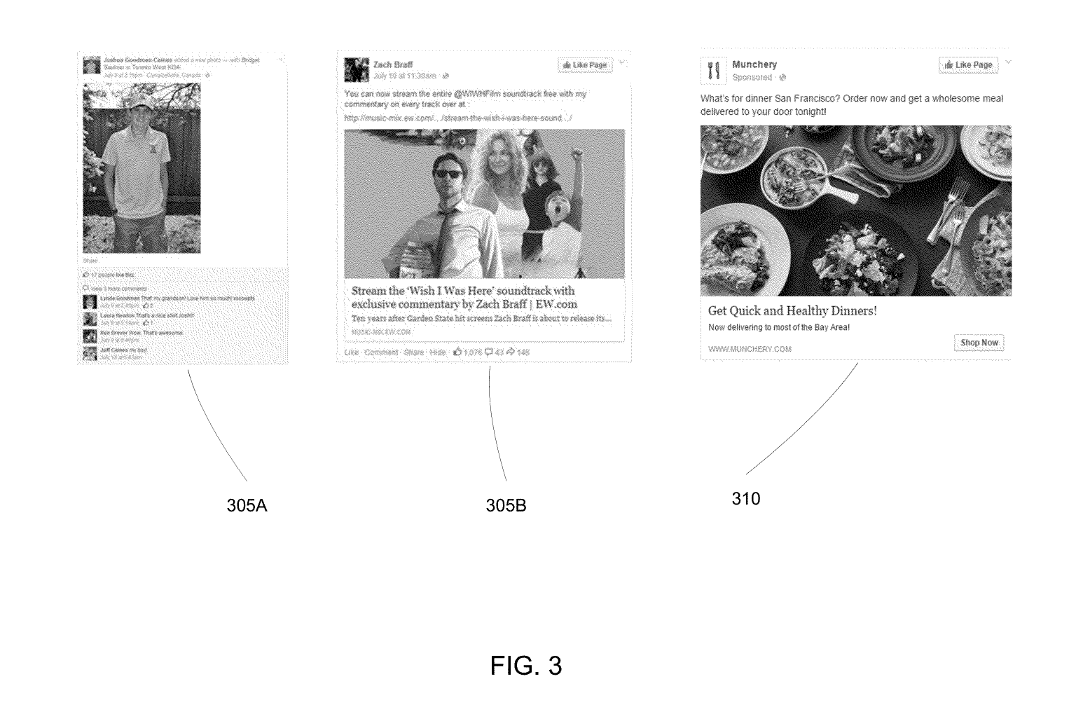

FIG. 3 shows examples of sponsored content items and non-sponsored content items presented to a social networking system user. As described above in conjunction with FIG. 2, the social networking system 140 presents various content items to a user. For example the social networking system 140 provides the user with a feed of content including one or more content items. A sponsored content item 310, which is a content item associated with a bid amount specifying an amount of monetary compensation received by the social networking system 140 if the content item is presented to a user, may be included in the feed of content presented to the user. For example, the sponsored content item 310 is an advertisement included in an ad request. Additionally, the feed may include one or more non-sponsored content items 305A and 305B (collectively referred to using reference number 305). A non-sponsored content item 305 is a content item for which the social networking system 140 does not receive monetary compensation for presenting to a user.

A content item includes various features describing the appearance of the content item when presented to a user. For example, a feature specifies one or more dimensions of image or video data included in the content item. Another feature may specify placement of text in the content item relative to image or video data included in the content item. Other features may identify a number of comments associated with the content item, a number of times the content item was communicated by a user to another user, a number of users who have indicated a preference for a content item, a user associated with the content item, text included in the content item, one or more sizes with which text included in the content item is presented, interface elements presented via the content item, and any other suitable information describing appearance of the content item when presented.

Non-sponsored content items 305 may have features that cause an appearance of a non-sponsored content item 305 to be similar to an appearance of a sponsored content item 310. Users are often less likely to interact with non-sponsored content items 305 with similar appearances to the appearance of a sponsored content item 310, so presenting multiple non-sponsored content items with similar appearances to an appearance of a sponsored content item 310 may decrease user interaction with content presented by the social networking system 140. In the example of FIG. 3, non-sponsored content item 305B has features specifying dimensions of an image and placement of text relative to the image that cause the appearance of non-sponsored content item 305B to be similar to the appearance of sponsored content item 310. For example, a social networking system user posts a link to content external to the social networking system 140, so the social networking system 140 generates a non-sponsored content item 305B including an image identifying the content external to the social networking system 140 and text provided by the user; however, the dimensions of the image and placement of text relative to the image in the non-sponsored content item 305B cause the non-sponsored content item 305B to appear similar to the sponsored content item 310. Similarly, a sponsored content item 310 may have features causing the appearance of the sponsored content item 310 to have an appearance similar to an appearance of a non-sponsored content item. In one example, an entity having a user profile maintained by the social networking system 140 generates a non-sponsored content item 305 for inclusion in a page associated with the entity and maintained by the social networking system 140. When a user of the social networking system 140 views non-sponsored content item on the page associated with the entity, the user determines, from one or more characteristics of the appearance of the non-sponsored content item 305, that the non-sponsored content item 305 has an appearance similar to an appearance of a sponsored content item 310.

To improve user interaction with provided content, the social networking system 140 generates a score for content items eligible for presentation to a user. A score for a content item provides a measure of similarity of an appearance of the content item to an appearance of a sponsored content item. As described below in conjunction with FIG. 4, one or more machine learned models are applied to features of the content item that specify appearance of the content item to generate the score. The one or more machine learned models may be trained based on feedback received from one or more users to content items from a training set presented to the one or more users and features of the content items from the training set that were presented to the one or more users. As described below in conjunction with FIG. 5, scores associated with various content items are used when selecting content items for presentation to a user. For example, scores associated with content items allow the social networking system 140 to limit presentation of sponsored content items or content items having appearances similar to an appearance of a sponsored content item to a user.

### Training One or More Machine Learned Models to Score Appearances of Content Items

FIG. 4 is a flowchart of one embodiment of a method for training one or more machine learned models model to generate a score providing a measure of similarity between an appearance of a content item and an appearance of a sponsored content item. In some embodiments, different and/or additional steps than those identified in conjunction with FIG. 4 may be performed. Additionally, in other embodiments the steps described in conjunction with FIG. 4 may be performed in different orders.

The social networking system 140 identifies 405 a training set of content items including one or more sponsored content items and one or more non-sponsored content items. In one embodiment, the training set includes content items previously presented to one or more social networking system users. Alternatively, the training set may include content items not previously presented to a user. Different training sets may be identified 405 for different social networking system users based on content items eligible for presentation to each social networking system user. For example, the training set identified 405 for a user includes ad requests including targeting criteria satisfied by characteristics of the user and non-sponsored content items describing actions associated with additional users connected to the user.

Each content item in the training set includes one or more features describing appearance of a content item when it is presented to a social networking system user, and the social networking system 140 identifies 410 features describing the appearance of each content item in the training set when presented to a user. As described above in conjunction with FIG. 3, features of a content item may specify one or more dimensions of image or video data included in the content item or placement of text in the content item relative to image or video data included in the content item. Additional examples of features specify: a number of comments associated with the content item, a number of times the content item was communicated by a user to another user, a number of users who have indicated a preference for a content item, a user associated with the content item, text included in the content item, one or more sizes with which text included in the content item is presented, interface elements presented via the content item, an n-gram analysis of text included in the content item, a subject or a topic associated with the candidate content item, or whether the candidate content item includes a link to content external to the social networking system 140, and any other suitable information describing appearance of the content item.

One or more content items from the training set are presented 415 to a user of the social networking system 140. After presentation of the one or more content items, the social networking system 140 receives 420 feedback from the user regarding the user's perception of the appearance of the presented one or more content items as sponsored content items or as non-sponsored content items. In one embodiment, the social networking system 140 presents one or more questions identifying a presented content item from the training set and prompting the user to indicate whether the presented content item appeared to be a sponsored content item. For example, the social networking system 140 presents a question to a user along with a content item from the training set prompting the user to identify the content item as appearing to be a sponsored content item or appearing to be a non-sponsored content item.

Based on the received 420 responses to the one or more questions, the social networking system 140 trains 425 one or more models to generate a score for a content item indicating a similarity between an appearance of a content item and an appearance of a sponsored content item. The social networking system 140 may associate weights with various features identified from a content item presented to the user based on whether the user presented with the content item identifies the content item as having an appearance of a sponsored content item. In one embodiment, the social networking system 140 increases weights associated with features of presented content items identified by the user as having an appearance of a sponsored content item. Weights associated with various features of content items presented from multiple training sets may be combined to improve the accuracy of the weights associated with various features in some embodiments. The trained model is stored 430 by the social networking system 140 for subsequent application to content items outside of the training set. In some embodiments, the social networking system 140 trains 425 and stores 430 different models in association with different users (e.g., a model associated with individual users, a model associated with groups of users having one or more common characteristics). Alternatively, the social networking system 140 trains 425 and stores 430 one or more models that are globally applied to content items selected for presentation to social networking system users. Application of the trained model to one or more content items selected for presentation to a user is further described below in conjunction with FIG. 5.

In one example, the user is presented with a set of ground truth questions prior to being prompted for feedback on a presented content item from the training set to determine a measure of reliability of the feedback received 420 from the user describing the user's perception of the presented content item. The user's responses to ground truth questions may affect the weights associated with features of the presented content item based on the feedback received 420 from the user. An example of a ground truth question presents the user with a known sponsored content item and increases a measure of reliability associated with the user if the user identifies the known sponsored content item presented to the user as having an appearance similar to an appearance of a sponsored content item. As another example, a ground truth question presents the user with a known non-sponsored content item and increases the measure of reliability associated with the user if a response from the user to the ground truth question identifies the known non-sponsored content item as having an appearance similar to an appearance of a non-sponsored content item.

The social networking system 140 may use various criteria to determine the extent to which a user's feedback affects the training of the model. For example, the social networking system 140 may disregard responses associated with a content item if there are less than a threshold number of responses associated with the content item. For instance, the social networking system 140 may disregard responses associated with a content item if less than two reliable responses were received for the content item. In another example, the social networking system 140 may disregard responses associated with a content item if less than a threshold percentage of the responses are of a specific type. For instance, the social networking system 140 may disregard responses to a content item if less than 60% of the responses for the content item identify the content item as a sponsored content item or a non-sponsored content item.

The social networking system 140 may also modify the training set based on the feedback received 420 from various users to when content in the training set is presented 415. For example, after receiving 420 a threshold amount of feedback for a content item, the content item is replaced in the training set by an alternative content item. Alternatively, if less than a threshold amount of feedback is received 420 when a content item is presented 415, the social networking system 140 may replace the content item with an alternative content item.

### Selecting Content Items for Presentation to a User Based in Part on Content Item Appearance

FIG. 5 is a flowchart of one embodiment of a method for selecting content items for presentation to a social networking system user. As used herein, “content items” refers to both non-sponsored content items and sponsored content items, such as advertisements. In some embodiments, the method includes different and/or additional steps than those identified in conjunction with FIG. 5. Additionally, the method may perform the steps described in conjunction with FIG. 5 in different orders in some embodiments.

The social networking system 140 obtains 505 content items eligible for presentation to a user. Non-sponsored content items eligible for presentation to the user include stories describing actions performed by additional users connected to the user via the social networking system 140. Sponsored content items eligible for presentation to the user include ad requests including targeting criteria satisfied by characteristics of the user. Any number of content items may be obtained 505.

One or more features of various obtained content items are identified 510 by the social networking system 140. Identified features of a content item describe appearance of the content item when it is presented to the user. As described above in conjunction with FIGS. 2 and 3, example features of a content item include: dimensions of an image included in the content item, positioning of text in the content item relative to an image included in the content item, a link to content external to the social networking system 140 included in the content item, font size of text included in the content item, and a user associated with the content item. Based on the identified features, the social networking system 140 scores 515 the content items. The score associated with a content item provides a measure of similarity of an appearance of the content item to an appearance of a sponsored content item (e.g., an advertisement). In one embodiment, a higher score for a content item indicates a greater similarity of the content item's appearance to an appearance of a sponsored content item. The social networking system 140 applies one or more machine learned models, which may be trained as described above in conjunction with FIG. 4, to features identified 510 from a content item to score 515 the content item. In one embodiment, a machine learned model associates weights with various features of a content item and generates the score for the content item based on the weights associated with the features of the content item.

Based at least in part on the scores associated with the content items, the social networking system 140 selects 520 content for presentation to the user. In one embodiment, the social networking system 140 identifies candidate content items based on likelihoods of the user interacting with the content items and bid amounts associated with content items. As described above in conjunction with FIG. 2, the social networking system 140 ranks non-sponsored content items and sponsored content items (e.g., ad requests) in a unified ranking based on bid amounts associated with sponsored content items and measures of relevance associated with non-sponsored content items and sponsored content items. Based on the unified ranking, the social networking system 140 selects 520 content items having at least a threshold position in the ranking for presentation to the user. For example, content items having at least a threshold position in the ranking are selected 520. Alternatively, the social networking system 140 separately ranks sponsored content items based on their bid amounts and expected likelihoods of user interaction and non-sponsored content items based on their expected likelihoods of user interaction and selects 520 content items from one or more of the rankings.

When selecting 520 content items, the social networking system 140 may modify expected likelihoods of user interaction with a content item based on the scores associated with the content items. In one embodiment, the social networking system 140 modifies a likelihood of user interaction with a content item based at least in part on the score associated with the content item. For example, the social networking system 140 decreases a likelihood of user interaction with a content item by a value if the score for the content item exceeds a threshold value. Alternatively, the social networking system 140 increases a likelihood of user interaction with a content item by an alternative value if the score for the content item is less than an alternative threshold value. In other implementations, the social networking system 140 decreases the likelihood of a user interacting with a content item by an amount that is proportional to the score for the content item (or increases the likelihood of a user interacting with a content item by an amount proportional to the score for the content item in embodiments where the score specifies a measure of similarity between an appearance of the content item and an appearance of a non-sponsored content item). In some embodiments, the social networking system 140 modifies an expected likelihood of user interaction with a content item based on a combination of the score for the content item and whether the content item is a sponsored content item or is a non-sponsored content item. For example, if a content item is associated with a bid amount and a score for the content item indicates the content item's appearance has at least a threshold similarity to an appearance of a non-sponsored content item (e.g., the score is less than a threshold value), the social networking system 140 increases the expected likelihood of user interaction with the content item or increases the bid amount associated with the content item. Hence, if a content item associated with a bid amount has a score less than a threshold amount, the position of the content item in the ranking is increased. Similarly, if a content item that is not associated with a bid amount has a score greater than the threshold amount, a position of the content item is decreased.

The social networking system 140 may also, or alternatively, apply one or more rules based on scores associated with content items when selecting 520 content items. For example, a rule specifies a minimum number of non-sponsored content items with an appearance of a non-sponsored content item presented between sponsored content items or content items having an appearance of a sponsored content item. When the social networking system 140 selects 520 a sponsored content item or a content item with an appearance having at least a threshold similarity to an appearance of a sponsored content item, the social networking system 140 subsequently selects 520 at least the minimum number of non-sponsored content items with an appearance having less than the threshold similarity to the appearance of a sponsored content item for subsequent presentation. In one embodiment, the social networking system 140 identifies sponsored content items and non-sponsored content items with appearances having at least the threshold similarity to an appearance of a sponsored content item as ineligible for presentation to the user after selecting 520 a sponsored content item or a non-sponsored content item with an appearance having at least a threshold similarity to an appearance of a sponsored content item until at least the minimum number of with an appearance of a non-sponsored content item have been selected 520.

Another rule may associate a maximum score with one or more positions in a feed of content. When the social networking system 140 selects a content item for presentation in a position identified by the rule, content items associated with scores greater than the maximum score are identified as ineligible for selection 520. An additional rule may specify a maximum ratio of content items with appearances similar to an appearance of a sponsored content item and content items with appearances not similar to the appearance of the sponsored content item for inclusion in the feed. Hence, when selecting 520 content items for inclusion in the feed, the social networking system 520 selects a number of content items having scores exceeding a threshold value (i.e., a number of content items having an appearance of a sponsored content item) and a number of content items having scores less than the threshold value (i.e., a number of content items having an appearance of a non-sponsored content item) so the maximum ratio is not exceeded.

The social networking system 140 provides 525 the selected content items to a client device 110 associated with the user for presentation. For example, the social networking system 140 communicates a feed including the selected content items to a client device 110 for presentation to the user. The selected content items may be provided 525 to the client device 110 in response to a request from the client device 110 for content or may be provided 525 to the client device 110 at periodic intervals. In other embodiments, the social networking system 140 may pushes the selected content items to the client device 110 after their selection.

### SUMMARY

The foregoing description of the embodiments has been presented for the purpose of illustration; it is not intended to be exhaustive or to limit the patent rights to the precise forms disclosed. Persons skilled in the relevant art can appreciate that many modifications and variations are possible in light of the above disclosure.

Some portions of this description describe embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the patent rights. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights, which is set forth in the following claims.

What is claimed is:

1. A computer-implemented method comprising:
obtaining content items maintained by a social networking system for presentation to a user of the social networking system;
identifying features of each content item describing appearances of the content items;
determining a score for each obtained content item, the score for a content item based at least in part on the identified features of the content item describing an appearance of the content item and the score providing a measure of similarity of an appearance of the content item to an appearance of a sponsored content item;
selecting content for presentation to the user of the social networking system from the obtained content items based at least in part on the determined scores; and
providing the selected content to a client device for presentation to the user.

2. The computer-implemented method of claim 1, wherein determining the score for each obtained content item comprises:
applying a trained model to the identified features of each obtained content item to generate the score for the content item

3. The method of claim 2, wherein the model is trained based on classification by one or more users of the social networking system of content items from a training set as having the appearance of the sponsored content item.

4. The computer-implemented method of claim 1, wherein selecting content for presentation to the user of the social networking system from the obtained content items based at least in part on the determined scores comprises:
ranking at least a set of the obtained content items based at least in part on likelihoods of the user interacting with content items in the set and bid amounts associated one or more content items included in the set;
modifying a position in the ranking of one or more content items in the set based at least in part on the scores associated with the one or more content items; and
selecting content for presentation to the user based at least in part on the modified positions in the ranking.

5. The computer-implemented method of claim 4, wherein modifying the position in the ranking of one or more content items in the set based at least in part on the scores associated with the one or more content items comprises:
increasing a position in the ranking of a content item associated with a bid amount if the score for the content item is less than a threshold value.

6. The computer-implemented method of claim 4, wherein modifying the position in the ranking of one or more content items in the set based at least in part on the scores associated with the one or more content items comprises:
decreasing a position in the ranking of a content item that is not associated with a bid amount if the score for the content item equals or exceeds a threshold value.

7. The computer-implemented method of claim 4, wherein modifying the position in the ranking of one or more content items in the set based at least in part on the scores associated with the one or more content items comprises:
modifying a likelihood of the user interacting with a content item included in the set by an amount based at least in part on a score associated with the content item included in the set; and
modifying a position of the content item included in the set based on the modified likelihood of the user interacting with the content item included in the set.

8. The computer-implemented method of claim 7, wherein modifying the likelihood of the user interacting with the content item included in the set by the amount based at least in part on the score associated with the content item included in the set comprises:
decreasing the likelihood of the user interacting with the content item included in the set by an amount proportional to the score associated with the content item included in the set.

9. The computer-implemented method of claim 1, wherein selecting content for presentation to the user of the social networking system from the obtained content items based at least in part on the determined scores comprises:
applying one or more rules based at least in part on the determined scores to the obtained content items.

10. The computer-implemented method of claim 9, wherein a rule specifies a minimum number of content items associated with scores less than a threshold value selected after selection of a content item associated with a bid amount.

11. The computer-implemented method of claim 9, wherein a rule associates a maximum score with a position in a feed of content.

12. A computer-implemented method comprising:
identifying a training set of content items maintained by a social networking system, including at least one or more content items associated with a bid amount;
identifying features of each content item in the training set, features associated with a content item describing appearance of the content describing appearances of the content items;
presenting one or more content items from the training set to a user of the social networking system;
receiving feedback from the user indicating whether the one or more content items have appearances matching an appearance of a content item associated with a bid amount;
training a model to generate a score providing a measure of similarity of an appearance of the content item to an appearance of the content item associated with the bid amount based at least in part on the received feedback and features of the presented one or more content items; and
storing the trained model in the social networking system.

13. The computer-implemented method of claim 12, wherein receiving feedback from the user indicating whether the one or more content items have appearances matching the appearance of the content item associated with the bid amount comprises:
presenting one or more questions identifying a presented content item that prompt the user to indicate whether the appearance of the presented content item matches the appearance of the content item associated with the bid amount; and
receiving a response to at least one of the presented one or more questions from the user.

14. The computer-implemented method of claim 12, wherein a feature of a content item included in the training set comprises one or more dimensions of image data included in the content item.

15. The computer-implemented method of claim 12, wherein a feature of a content item included in the training set specifies placement of text in the content item relative to image data included in the content item.

16. A computer program product comprising a computer readable storage medium having instructions encoded thereon that, when executed by a processor, cause the processor to:
obtain content items maintained by a social networking system for presentation to a user of the social networking system;
identify features of each content item describing appearances of the content items;
determine a score for each obtained content item, the score for a content item based at least in part on the identified features of the content item describing an appearance of the content item and the score providing a measure of similarity of an appearance of the content item to an appearance of a sponsored content item;
select content for presentation to the user of the social networking system from the obtained content items based at least in part on the determined scores; and
provide the selected content to a client device for presentation to the user.

17. The computer program product of claim 16, wherein determine the score for each obtained content item comprises:
apply a trained model to the identified features of each obtained content item to generate the score for the content item

18. The computer program product of claim 17, wherein the model is trained based on classification by one or more users of the social networking system of content items from a training set as having the appearance of the sponsored content item.

19. The computer program product of claim 16, wherein select content for presentation to the user of the social networking system from the obtained content items based at least in part on the determined scores comprises:
rank at least a set of the obtained content items based at least in part on likelihoods of the user interacting with content items in the set and bid amounts associated one or more content items included in the set;
modify a position in the ranking of one or more content items in the set based at least in part on the scores associated with the one or more content items; and
select content for presentation to the user based at least in part on the modified positions in the ranking.

20. The computer program product of claim 16, wherein select content for presentation to the user of the social networking system from the obtained content items based at least in part on the determined scores comprises:
apply one or more rules based at least in part on the determined scores to the obtained content items.
